(19) United States
(12) Patent Application Publication
(10) Pub. No.: US 2011/0051282 A1
(43) Pub. Date: Mar. 3, 2011

(54) MAGNETIC RECORDING MEDIUM, MAGNETIC RECORDING AND REPRODUCING APPARATUS, AND METHOD FOR MANUFACTURING MAGNETIC RECORDING MEDIUM

(76) Inventor: Masato Fukushima, Chiba-shi (JP)

(21) Appl. No.: 12/990,187

(22) PCT Filed: Apr. 24, 2009
(86) PCT No.: PCT/JP2009/058175

§ 371 Date: Oct. 28, 2010

(30) Foreign Application Priority Data
May 1, 2008 (JP) 2008-119769

(51) Int. Cl. G11B 21/02; G11B 5/82; G11B 5/84

(52) U.S. Cl. 360/75; 360/135; 216/22

(57) ABSTRACT

There is provided a magnetic recording medium which can be manufactured at a high production efficiency, and in which a protruding section constituted of a magnetic layer can be separated by a recessed separating region, and stability for the floating properties of the magnetic head is excellent,

the magnetic recording medium including, on at least one surface of a disc-shaped substrate, an annular magnetic recording region (A); and a landing region (B) arranged along the edge portion of the magnetic recording region (A); a data region (41) in which a data pattern (45) configured from a protruding section (43a) constituted of a magnetic layer and a recessed separating region (44a) formed in the periphery of the protruding section (43a) is provided, and a servo information region (42) in which a servo pattern (46) configured from the protruding sections (43b) and (43c) and the separation region (44b) and having a different shape from that of the data pattern (45) when seen in plan view, in the magnetic recording region (A); and an uneven pattern (47) having a protruding section (43d) with the same shape as that of the protruding section (43a) in the data pattern (45) and provided in at least a portion of the landing region (B).

### TECHNICAL FIELD

The present invention relates to a magnetic recording medium to be used in a hard disk device or the like, and a magnetic recording and reproducing apparatus.

Priority is claimed on Japanese Patent Application No. 2008-119769, filed May 1, 2008, the content of which is incorporated herein by reference.

### BACKGROUND ART

In recent years, the application range of magnetic recording apparatuses, such as magnetic disk apparatuses, flexible disk apparatuses and magnetic tape apparatuses, has increased considerably, and the importance thereof has also increased. At the same time, an attempt is being made to highly increase the recording density of magnetic recording media used for these apparatuses. In particular, since the introduction of a magnetoresistive (MR) head and a partial response maximum likelihood (PRML) technology, increase in the surface recording density has accelerated even more, and with the introduction of a giant magnetoresistive (GMR) head, a tunnel magnetoresistive (TMR) head or the like in recent years, the recording density has continued to increase at a rate as high as about 100% per year. Regarding these magnetic recording media, there is a demand for a further increase in the recording density in the future. It is therefore required to achieve a higher coercive force, a higher signal-to-noise ratio (SNR) and a higher resolution for a magnetic layer. In addition, in recent years, attempts have also been constantly made to increase the surface recording density by increasing the track density together with the improvements in the linear recording density.

The most recent magnetic recording apparatuses have a track density of as high as 110 kTPI. However, as the track density increases, magnetically recorded information on adjacent tracks interferes with each other, and as a result, the magnetic transition regions at their boundary regions become a noise source, which may easily impair the SNR. This directly results in deterioration of the bit error rate, which is a drawback for improving the recording density. In order to increase the surface recording density, it is necessary to make the size of each recording bit on the magnetic recording medium finer and to secure the greatest possible levels of saturation magnetization and magnetic film thickness for each recording bit. However, as the recording bit becomes finer, the minimum magnetization volume per 1 bit becomes small. As a result, the problem of loss of recorded data due to the magnetization reversal caused by heat fluctuation will occur.

In addition, since the adjacent tracks come close to each other when the track density is increased, a track servo technique with extremely high precision has been demanded for the magnetic recording apparatus. Moreover, in order to eliminate as much influence as possible from adjacent tracks, a method of executing recording widely and executing reproduction more narrowly than during recording in order to eliminate as much influence as possible from adjacent tracks is generally employed. In this method, the influence between adjacent tracks can be suppressed to the minimum level. On the other hand, it is difficult to obtain satisfactory reproduction output. Therefore, it is difficult to secure a satisfactory level of S/N ratio (SNR).

As one of the methods for solving such a problem of heat fluctuation, securing an adequate level of S/N ratio, or securing the sufficient output, an attempt to increase the track density has been made by forming an uneven pattern along the tracks on the surface of a recording medium so as to physically or magnetically separate the recording tracks from one another. Hereafter, such a technique will be referred to as a discrete track method, and a magnetic recording medium manufactured by the technique will be referred to as a discrete track medium.

As an example of such a discrete track medium, there is known a magnetic recording medium in which a soft magnetic layer and a ferromagnetic layer are laminated on top of a nonmagnetic substrate having a plurality of protruding sections and concave portions surrounding each of the protruding sections, an uneven pattern reflecting the shape of the nonmagnetic substrate is formed in the soft magnetic layer and the ferromagnetic layer, and protruding sections in the ferromagnetic layer which are magnetically isolated are serving as a recording region (for example, refer to Patent Document 1).

According to this magnetic recording medium, since the generation of a magnetic wall in the soft magnetic layer can be suppressed, the influence of heat fluctuation is hardly exhibited, and there is no interference between adjacent signals. Therefore, it is considered that a magnetic recording medium having a high density with less noise can be formed.

As a method for manufacturing a discrete track medium, the following two methods are available. That is, a method of forming tracks after a magnetic recording medium composed of several layers of thin films is formed, and a method of forming thin films of a magnetic recording medium after an uneven pattern is formed, either directly on the surface of a substrate in advance or on a thin film layer for the formation of tracks (for example, refer to Patent Documents 2 and 3). Of these, the former method is often referred to as a magnetic layer processing method. On the other hand, the latter method is often referred to as an embossing method.

In general, a magnetic recording medium having a discrete pattern or a bit pattern is manufactured by forming a magnetic layer having an uneven shape on the surface thereof and then filling in the concave portions of the uneven shape with a nonmagnetic material so as to smooth the surface. When a magnetic recording medium has a smooth surface, it is preferable since excellent stability can be achieved for the floating properties of the magnetic head. However, in those cases where a magnetic recording medium is manufactured by this method, there has been a high possibility of contaminating the surface of the magnetic recording medium when filling in the concave portions with a nonmagnetic material and smoothing the surface. In addition, in those cases where the concave portions are filled in with a nonmagnetic material, the manufacturing process becomes complicated and troublesome, which also leads to the increase in cost for manufacturing a magnetic recording medium.

Further, as a method for manufacturing a discrete type magnetic recording medium, there is also a method of forming recording tracks by conducting ion implantation or laser irradiation from the outside, thereby locally changing the magnetic properties of a desired portion in the continuous magnetic layer on a nonmagnetic substrate (for example, refer to Patent Document 4). When adopting this method, the surface of the magnetic recording medium can be made smooth since the recording tracks can be formed without filling in with a nonmagnetic material.

In addition, as a discrete track medium in which a landing zone for the magnetic head is formed, a magnetic recording medium configured from a data zone in which a pattern separated by a groove and used as a recording track is formed, and a landing zone for the magnetic head which is positioned in the outermost periphery without the aforementioned pattern being formed, has been disclosed (for example, refer to Patent Document 5). According to the technique described in Patent Document 5, since the landing zone for a head slider is a region without an uneven pattern, the floating stability of the head slider can be improved.

Incidentally, in a hard disk drive incorporating a magnetic recording medium, the magnetic head is made to float above the surface of the magnetic recording medium by generally rotating the magnetic recording medium at 5,000 rpm or more. In those cases where the rotation of magnetic recording medium is stopped in the hard disk drive, the magnetic head does not float, which makes the magnetic head to come into contact with the magnetic recording medium. At this time, when the surface of the magnetic head which is opposite to the magnetic recording medium and the surface of the magnetic recording medium are sufficiently smooth, both surfaces rigidly attach to each other, and there are some cases where the magnetic recording medium cannot be rotated even when the hard disk drive is restarted. For this reason, in the hard disk drive, there is provided either a mechanism for automatically levitate and withdraw the magnetic head from the surface of the magnetic recording medium when the magnetic recording medium stopped rotating, or a region (a texture region) with a roughened surface within a specified portion of the surface of the magnetic recording medium so as to prevent the attachment of the magnetic head thereto even if the contact occurs.

[Patent Document 1] Japanese Unexamined Patent Application, First Publication No. 2004-164692

[Patent Document 2] Japanese Unexamined Patent Application, First Publication No. 2004-178793

[Patent Document 3] Japanese Unexamined Patent Application, First Publication No. 2004-178794

[Patent Document 4] Japanese Unexamined Patent Application, First Publication No. Hei 5-205257

[Patent Document 5] Japanese Unexamined Patent Application, First Publication No. 2006-031850

### DISCLOSURE OF INVENTION

However, when adopting the technique described in Patent Document 4, there has been a possibility that a magnetic isolation between the recording tracks may become inadequate, as compared to the cases where the recording tracks are separated by the grooves.

In addition, since an uneven pattern of the magnetic recording layer is formed on the surface of a magnetic disk, satisfactory stability for the floating properties of the magnetic head may not be achieved, although the recording tracks can be separated by the grooves.

The present invention has been made in view of the above circumstances with an object of providing a magnetic recording medium which can easily be manufactured at a high production efficiency without conducting a step for filling in a concave portion with a nonmagnetic material and smoothing the concave portion, the magnetic recording medium in which a protruding section constituted of a magnetic layer can be separated by a recessed separating region, and the magnetic recording medium which exhibits excellent stability for the floating properties of the magnetic head and which can also be applied to high density recording.

In addition, another object of the present invention is to provide a magnetic recording and reproducing apparatus capable of reducing the floating level of the magnetic head and which is highly stable and achieves high recording density.

As a method for manufacturing a magnetic recording medium, the present inventors have developed a method of providing a mask layer that corresponds to the magnetic recording pattern on the surface of the magnetic layer and causes the magnetic layer which is not covered with the mask layer to chemically react with oxygen or the like, thereby partially non-magnetizing the magnetic layer. The present inventors have further conducted intensive and extensive studies and discovered that when adopting this method, reactivity between the oxygen or the like and the magnetic layer increase if the surface of a reaction region within the magnetic layer in which a chemical reaction with oxygen or the like takes place is slightly removed.

However, if the surface of a reaction region within the magnetic layer is removed, as a result, an uneven pattern is formed on the surface of the obtained magnetic recording medium. When an uneven pattern is present on the surface of a magnetic recording medium, stability for the floating properties of the magnetic head is impaired. Therefore, it is preferable that a magnetic recording medium have a smooth surface. However, if the concave portions are filled in with a nonmagnetic material in order to smooth the surface of the magnetic recording medium, as mentioned above, problems arise, such as the contamination of the surface of the magnetic recording medium and the complicated manufacturing process.

Accordingly, the present inventors have conducted an analysis to solve the problem of frequent breakage of magnetic head which occurred in the hard disk drive employing a magnetic recording medium with an uneven surface. As a result, when the magnetic head is floating in the magnetic recording region of a magnetic recording medium, it was found that the magnetic head oscillates at a boundary portion between the data region and the servo information region. In addition, it was also found that when the magnetic head is moved from the landing region to the magnetic recording region within a magnetic recording medium, the magnetic head oscillates at a boundary portion between the data region and the servo information region, and thus the magnetic head is momentarily brought into contact with the magnetic recording medium to break.

More specifically, it became apparent that, for example, in a discrete type magnetic recording medium in which a data pattern has a regular uneven shape and a servo pattern has an irregular uneven shape, although the recording tracks can be magnetically separated by the grooves, the floating properties of the magnetic head are likely to become unstable when the magnetic head moves either from the servo information region to the data region or from the data region to the servo information region.

The instability of the floating properties can be alleviated to some extent by optimizing the shape of the data pattern in the data region and the shape of the servo pattern in the servo information region. However, according to the intensive extensive studies conducted by the present inventors, it was impossible to solve the problem of instability even when the shapes of the data pattern and servo pattern had been optimized. In particular, it was difficult to suppress the momentarily oscillation of the magnetic head when the magnetic head enters the servo information region from the data region. In addition, it was difficult to prevent the magnetic head to momentarily come into contact with the magnetic recording medium when the magnetic head moves from the withdrawn position to the magnetic recording region and also when the magnetic head enters the servo information region from the data region.

One possible method in order to solve this problem is to provide a region with no uneven pattern in a magnetic recording medium as a landing region, and to elevate the floating level of the magnetic head in the landing region. However, if a landing region with no patterns formed is provided, the difference between the floating properties of the magnetic head in the landing region and those in the data region increases, which increases the possibility of the magnetic head to come into contact with the magnetic recording medium when the magnetic head enters the servo information region from the data region.

In addition, another possible method is to roughen the surface of the landing region to make it a texture region, thereby somewhat lowering the floating level of the magnetic head in the landing region. However, even when a landing region with a roughened surface is provided, it is difficult to make the level of the floating properties of the magnetic head in the landing region completely the same as that in the magnetic recording region, and thus a satisfactory stability for the floating properties of the magnetic head cannot be achieved.

The present inventors have further conducted intensive and extensive studies to solve this problem, to improve the stability for the floating properties of the magnetic head, and to thereby prevent the contact between the magnetic head and the magnetic recording medium. As a result, the present inventors discovered that the problem may be solved by providing, in the landing region, an uneven pattern with a protruding section having the same shape as that of the protruding section in the data pattern of the data region, and thereby approximating the floating properties of the magnetic head in the landing region with those in the magnetic recording region. In such a magnetic recording medium, the floating properties of the magnetic head is stabilized in advance in the landing region before moving the magnetic head from the landing region to the magnetic recording region, and only then the magnetic head is moved to the magnetic recording region. For this reason, the extent of oscillation of the magnetic head occurring in the boundary portion between the data region and the servo information region when the magnetic head moves from the landing region to the magnetic recording region can be alleviated, and the magnetic head can also be prevented from momentarily coming into contact with the magnetic recording medium when the magnetic head is entering the servo information region from the data region. That is, the present invention relates to the following aspects.

(1) A magnetic recording medium characterized by including an annular magnetic recording region and a landing region arranged along the edge portion of the magnetic recording region on at least one surface of a disc-shaped substrate; wherein the magnetic recording region includes a data region in which a data pattern configured from a protruding section constituted of a magnetic layer and a recessed separating region formed in the periphery of the protruding section is provided, and a servo information region in which a servo pattern configured from the protruding section and the separation region and having a different shape from that of the data pattern when seen in plan view; and the landing region includes an uneven pattern having a protruding section with the same shape as that of the protruding section in the data pattern.

(2) The magnetic recording medium according to the above aspect (1), characterized in that the landing region substantially does not have a protruding section with the same shape as that of the protruding section in the servo pattern.

(3) The magnetic recording medium according to the above aspect (1) or (2), characterized in that a difference between the maximum value and the minimum value for an area ratio of the separation region within each of the data region, the servo information region and the landing region is 10% or less.

(4) The magnetic recording medium according to any one of the above aspects (1) to (3), characterized in that all area ratios of the separation region within each of the data region, the servo information region and the landing region are within a range from 10% to 50%.

(5) The magnetic recording medium according to any one of the above aspects (1) to (4), characterized in that the protruding section in the data region is a track portion.

(6) The magnetic recording medium according to any one of the above aspects (1) to (5), characterized in that a depth of the separation region with respect to the protruding section is within a range from 0.1 nm to 15 nm.

(7) The magnetic recording medium according to any one of the above aspects (1) to (6), characterized in that the data pattern and the uneven pattern have a regular uneven shape configured from a protruding section and a separation region that are extended in the circumferential direction of the substrate in a band-like manner at regular intervals.

(8) A magnetic recording and reproducing apparatus characterized by having the magnetic recording medium described in any one of the above aspects (1) to (7), a driving section for driving the magnetic recording medium in a recording direction, a magnetic head constituted of a recording section and a reproducing section, a device for moving the magnetic head relative to the magnetic recording medium, and a recording/reproducing signal processing device for supplying input signals to the magnetic head and reproducing output signals from the magnetic head.

(9) A method for manufacturing a magnetic recording medium which is a method for manufacturing the magnetic recording medium described in any one of the above aspects (1) to (7), characterized by having, at least, a step for forming a magnetic layer on top of the substrate, a step for forming a mask layer in a region on the magnetic layer which is to become the protruding section, a step for removing a surface layer portion of the magnetic layer in a region which is to become the separation region, a step for modifying magnetic properties of the magnetic layer in a region where the surface layer portion has been removed, and a step for removing the mask layer.

According to the magnetic recording medium of the present invention, although the medium is provided with a data pattern, a servo pattern, and an uneven pattern which are configured from a protruding section and a separation region on at least one surface of the substrate thereof, since an uneven pattern having a protruding section with the same shape as that of the protruding section of the data pattern is provided at least in a portion of the landing region, the extent of oscillation of the magnetic head occurring in the boundary portion between the data region and the servo information region when the magnetic head moves from the landing region for the magnetic recording medium to the magnetic recording region can be alleviated. Therefore, the magnetic recording medium of the present invention exhibits excellent stability for the floating properties of the magnetic head and is capable of preventing the magnetic head from coming into contact with the magnetic recording medium.

In addition, the magnetic recording medium of the present invention includes a data region in which a data pattern configured from a protruding section constituted of a magnetic layer and a recessed separating region formed in the periphery of the protruding section is provided, and a servo information region in which a servo pattern configured from the protruding section and the separation region and having a different shape from that of the data pattern when seen in plan view, in the magnetic recording region. Accordingly, the protruding sections constituted of a magnetic layer can be separated by a recessed separating region, and thus the protruding sections can be magnetically isolated in a reliable manner.

Further, since the magnetic recording medium of the present invention is provided with a data pattern, a servo pattern, and an uneven pattern which are configured from a protruding section and a separation region on at least one surface of the substrate thereof, there is no need to carry out a step for filling in and smoothing the concave portion with a nonmagnetic material, and thus the magnetic recording medium can be easily manufactured at a high production efficiency, as compared to the case where the step for filling in and smoothing the concave portion with a nonmagnetic material is carried out.

Moreover, since the magnetic recording medium of the present invention includes a servo information region in which a servo pattern configured from the protruding section and the separation region and having a different shape from that of the data pattern when seen in plan view, in the magnetic recording region, it is possible for the magnetic head to read, in the servo information region, the track information and sector information of the corresponding data region, and to read or write information in the data region.

Furthermore, since the magnetic recording medium of the present invention includes a servo information region configured from the protruding section and the separation region, there is no need to magnetically write the servo information in the data region (i.e., no need for servo writing), and thus productivity of the magnetic recording medium can be enhanced.

In addition, since the magnetic recording and reproducing apparatus of the present invention includes the magnetic recording medium of the present invention and exhibits excellent stability for the floating properties of the magnetic head, the contact between the magnetic head and the magnetic recording medium can be prevented, the floating level of the magnetic head can be reduced and stable electromagnetic conversion characteristics can be secured, thereby achieving a high recording density.

### BRIEF DESCRIPTION OF THE DRAWINGS

FIG. 1 is a plan view for explaining an example of a discrete type magnetic recording medium, and FIG. 1(a) is an enlarged schematic view in which only a partial region of the discrete type magnetic recording medium shown in FIG. 1(b) as a rectangle is enlarged and shown, and FIG. 1(b) is a schematic view showing the entire discrete type magnetic recording medium.

FIG. 2 is a cross sectional view for explaining a cross sectional structure of the discrete type magnetic recording medium shown in FIG. 1, and is an enlarged schematic view in which a portion of a data region of the discrete type magnetic recording medium is seen from the radial direction.

FIG. 3 is a schematic view for explaining a state where a magnetic head is floating above the discrete type magnetic recording medium shown in FIG. 1.

FIG. 4 is a schematic process drawing for explaining a method for manufacturing the discrete type magnetic recording medium of the present embodiment shown in FIGS. 1 to 3.

FIG. 5 is a schematic perspective view showing an example of a magnetic recording and reproducing apparatus of the present invention.

FIG. 6 is a schematic view showing a head gimbal assembly provided in the magnetic recording and reproducing apparatus shown in FIG. 5.

### BEST MODE FOR CARRYING OUT THE INVENTION

Next, a magnetic recording medium of the present invention and the manufacturing method thereof will be described in detail with reference to the drawings. It should be noted that in the drawings referred to in the following descriptions, the dimensions of each component in the drawings, such as the size and thickness thereof, may be different from the dimensions of the actual magnetic recording medium and the magnetic recording and reproducing apparatus.

### <Discrete Type Magnetic Recording Medium>

First, as an example of the magnetic recording medium of the present invention, an example of a discrete type magnetic recording medium will be described.

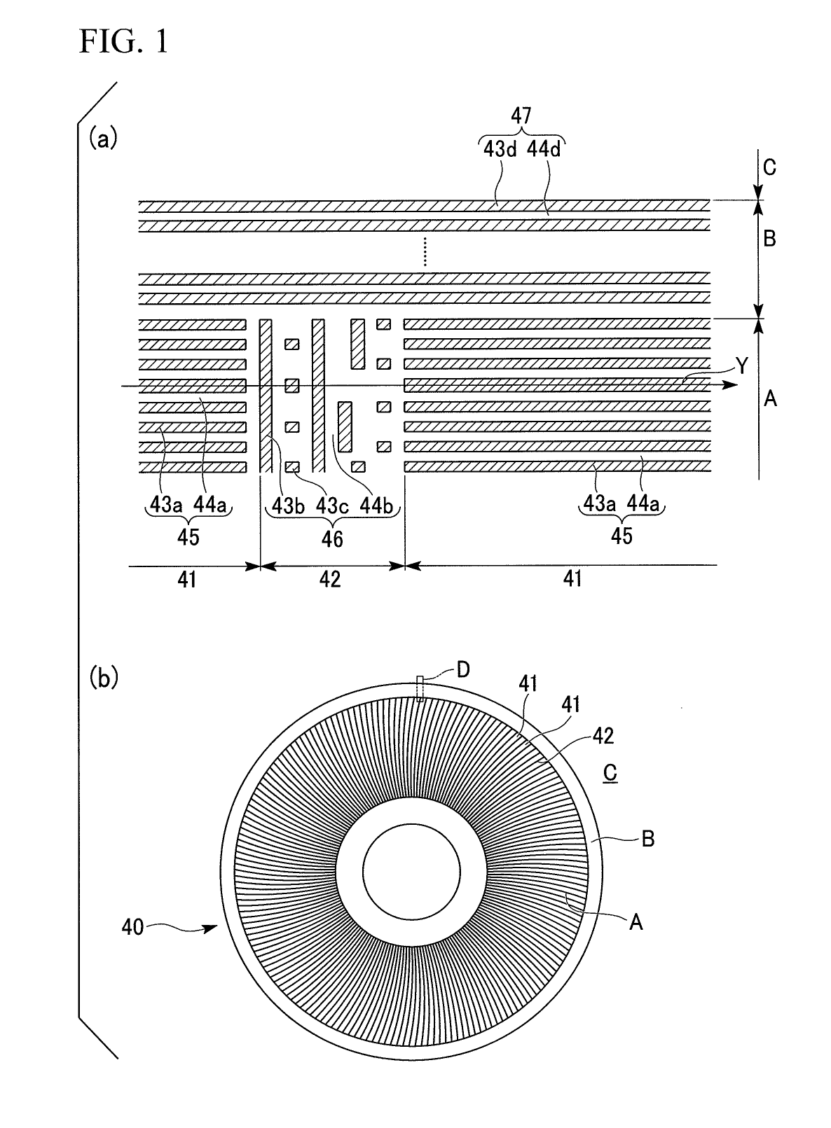

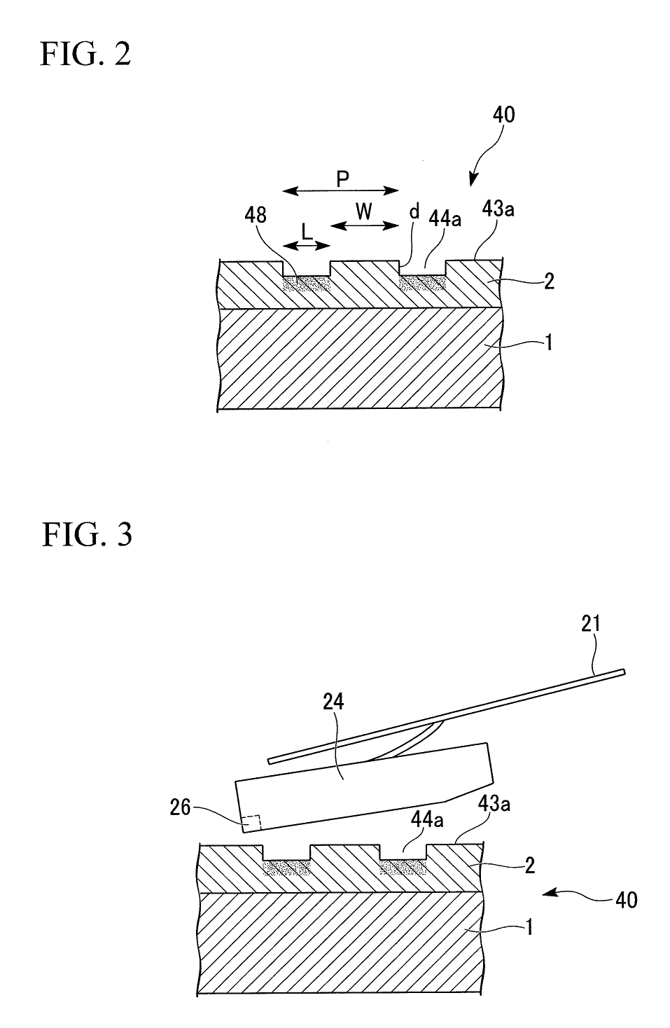

FIG. 1 is a plan view for explaining an example of a discrete type magnetic recording medium, and FIG. 1(a) is an enlarged schematic view in which only a partial region D of the discrete type magnetic recording medium shown in FIG. 1(b) as a rectangle is enlarged and shown, and FIG. 1(b) is a schematic view showing the entire discrete type magnetic recording medium. In addition, FIG. 2 is a cross sectional view for explaining a cross sectional structure of the discrete type magnetic recording medium shown in FIG. 1, and is an enlarged schematic view in which a portion of a data region of the discrete type magnetic recording medium is seen from the radial direction. Note that in FIG. 2, only a substrate and a magnetic layer are shown for making the explanation easy. In addition, FIG. 3 is a schematic view for explaining a state where a magnetic head is floating above the discrete type magnetic recording medium shown in FIG. 1.

A discrete type magnetic recording medium 40 shown in FIG. 1 includes, as shown in FIG. 1(b), an annular magnetic recording region A and a landing region B arranged concentrically with respect to a disc-shaped substrate along the outer edge portion of the magnetic recording region A, on one surface of the disc-shaped substrate.

As shown in FIG. 1(a), a data region 41 and a servo information region 42 are provided in the magnetic recording region A. Note that in FIG. 1(b), a region shown by the lines extending radially from the center corresponds to the servo information region 42, and the region between the radial lines corresponds to the data region 41. As shown in FIG. 1(b), the bulk of the magnetic recording region A is constituted of the data region 41, and the area for the servo information region 42 is small as compared to the area for the data region 41.

In addition, as shown in FIG. 1(b), although numerous data regions 41 are provided on the surface of the discrete type magnetic recording medium 40, each of these data regions 41 is positioned by the track information and sector information which are recorded in the servo information region 42.

An arrow Y shown in FIG. 1(a) indicates the moving position and moving direction of a magnetic head within the surface of the discrete type magnetic recording medium 40. A magnetic head that moves in the circumferential direction as indicated by the arrow Y first reads, in the servo information region 42, the track information and sector information for the corresponding data region 41, and then conducts a fine adjustment for the track position in a burst pattern region (not shown) provided on the same circumference, and thereafter conducts a reading/writing of information in the data region 41.

The discrete type magnetic recording medium 40 shown in FIG. 1 has a magnetic layer 2 formed on the surface of a disc-shaped substrate 1 as shown in FIG. 2, and a protective film layer (not shown in FIG. 2) is formed on top of the magnetic layer 2, and a lubricating layer (not shown in FIG. 2) is further formed on the outermost surface. Although the magnetic layer 2 may be either an in-plane magnetic layer or a perpendicular magnetic layer, a perpendicular magnetic layer is preferable in order to achieve a higher recording density.

As shown in FIGS. 1 and 2, in the magnetic layer 2 of the data region 41, data patterns 45 configured from protruding sections 43a and recessed separating regions 44a formed in the periphery of the protruding sections 43a are provided. In the data patterns 45, he recessed separating regions 44a magnetically separate between the protruding sections 43a constituted of the magnetic layer. As shown in FIG. 1(a), the protruding sections 43a and the separation regions 44a that constitute the data patterns 45 are extended in the circumferential direction of the substrate in a band-like manner at regular intervals so as to configure a regular uneven shape.

In addition, as shown in FIG. 1(a), in the servo information region 42, a servo pattern 46 configured from protruding sections 43b and 43c constituted of a magnetic layer and recessed separating regions 44b formed in the periphery of the protruding sections 43b and 43c is provided. In the servo pattern 46, the recessed separating regions 44b magnetically separate between the protruding sections 43b and 43c constituted of the magnetic layer. The protruding sections 43b and 43c configuring the servo pattern 46 are constituted of the band-like protruding sections 43b formed in the radial direction of the substrate in a band-like manner and the dot-like protruding sections 43c formed in a dot-like manner. In the servo pattern 46, the track information and sector information are recorded as digital information. In addition, the servo pattern 46 has an irregular uneven shape and has a different shape from that of the data pattern 45 when seen in plan view.

The landing region B is provided for stabilizing the floating of the magnetic head before the magnetic head moves from the withdrawn position C shown in FIG. 1(a) and FIG. 1(b) to the magnetic recording region A. Although the width of the landing region B is not particularly limited, in order to effectively stabilize the floating of the magnetic head, it is preferably about equal to or more than the width of a head slider.

In the discrete type magnetic recording medium 40 of the present embodiment, as shown in FIG. 1(a), uneven patterns 47 configured from protruding sections 43d constituted of a magnetic layer and recessed separating regions 44d formed in the periphery of the protruding sections 43d is provided all over the landing region B. In the uneven patterns 47, the recessed separating regions 44d magnetically separate between the protruding sections 43d constituted of the magnetic layer. The protruding sections 43d and the separation regions 44d that constitute the uneven patterns 47 are extended in the circumferential direction of the substrate in a band-like manner at regular intervals, and the uneven patterns 47 have the same shape as that of the data patterns 45. Accordingly, in the landing region B, a portion having the same shape as the servo patterns 46 provided in the servo information region 42 is not substantially included.

Note that although it is preferable that the uneven patterns 47 have the same shape as that of the data patterns 45, the uneven patterns 47 may be those including the protruding sections 43d having the same shape as that of the protruding sections 43a of the data patterns 45. Here, the description “the protruding sections 43d of the uneven patterns 47 have the same shape as that of the protruding sections 43a of the data patterns 45” includes not only the cases where the protruding sections 43d of the uneven patterns 47 have completely the same shape as that of the protruding sections 43a of the data patterns 45, but also the cases where both shapes are similar. Examples of the cases where the both shapes are similar include those cases where the lengths of the protruding sections in the extending direction are different.

In addition, in the discrete type magnetic recording medium 40 of the present embodiment, it is preferable to make the protruding sections 43a in the data region 41 a track portion, in other words, to be made into a discrete type magnetic recording medium.

Further, in the discrete type magnetic recording medium 40 of the present embodiment, as shown in FIG. 2, the width W of the protruding sections 43a and 43d in the data region 41 and the landing region B, respectively, is preferably 200 nm or less for the sake of increasing the recording density, and the width L of the recessed separating regions 44a and 44d is preferably 100 nm or less. Therefore, it is preferable that a track pitch P (which equals the width W of the protruding sections plus the width L of the separation regions) be 300 nm or less and within a narrow range as much as possible.

In addition, in the present embodiment, it is preferable that the depths (indicated by the reference symbol d in FIG. 2) of the separation regions with respect to the protruding sections in each of the data region 41, the servo information region 42 and the landing region B, be the same and within a range from 0.1 nm to 15 nm. If the above-mentioned depth of the separation regions is within a range from 0.1 nm to 15 nm, the adjacent protruding sections can be magnetically separated even more reliably, and even more stable floating properties for the magnetic head can be achieved.

When the above-mentioned depth of the separation regions is less than 0.1 nm, there is a possibility that the magnetic separation of adjacent track portions may not be achieved satisfactorily. In addition, when the above-mentioned depth of the separation regions exceeds 15 nm, the air flow generated between the surface of the discrete type magnetic recording medium 40 and the magnetic head may become unstable, which may extremely deteriorate the floating properties of the magnetic head.

The recessed separating regions in each of the data region 41, the servo information region 42 and the landing region B are formed by removing a surface layer portion of a predetermined part within the magnetic layer 2. As shown in FIG. 2, the lower portion of the separation regions is made into a magnetic properties-impaired region 48 in which the magnetic properties are impaired by non-magnetization or the like. Accordingly, in the discrete type magnetic recording medium 40 of the present embodiment, due to the synergistic effect caused by the impairment of magnetic properties in the magnetic properties-impaired region 48 and the separation of the magnetic layer 2 by the recessed separating regions, the protruding sections that are magnetically separated from the adjacent protruding sections are formed.

Note that in terms of the concept “the protruding sections that are magnetically separated from the adjacent protruding sections” referred to in the present invention, as shown in FIG. 2, as long as the magnetic layer 2 is separated when seen from the surface side of the discrete type magnetic recording medium 40, even if the separation is not attained in the bottom portion of the magnetic layer 2, the object of the present invention can be achieved, and thus this case is also included in the concept of “the protruding sections that are magnetically separated from the adjacent protruding sections” in the present invention.

In addition, in the discrete type magnetic recording medium 40 of the present embodiment, as shown in FIG. 1(a), it is preferable that uneven patterns 47 having the same shape as that of the data patterns 45 be provided all over the landing region B. However, in order to attain the effects of the present invention, provision of an uneven pattern 46 which includes the protruding sections 43d having the same shape as that of the protruding sections 43a of the data patterns 45 in at least a portion of the landing region B may be enough, and a region in which no uneven pattern 46 is provided or a region where a pattern having a different shape from that of the data patterns 45 is provided may be present in the landing region B. Accordingly, even when the servo pattern 46 of the servo information region 42 is included in the landing region B, it can be tolerated as long as the extent of inclusion is slight, the similarity between the shape of the uneven patterns 47 and the shape of the data patterns 45 is substantially ensured, and the effects of the present invention are achieved.

In those cases where the uneven pattern 46 which includes the protruding sections 43d having the same shape as that of the protruding sections 43a of the data patterns 45 is provided only in a portion of the landing region B, it is preferable that the difference between the area ratio b of the separation regions 44a within the data region 41 ((area of separation regions 44a)/(area of data region 41)×100) and the area ratio c of the separation regions 44d within the landing region B ((area of separation regions 44d)/(area of landing region)×100), i.e., (b−c) be within a range from minus 10% to plus 10% (−10% ≦b−c≦+10%).

The floating level of the magnetic head changes due to the change in the wind pressure that the head slider receives to which the magnetic head is attached. Accordingly, when the area ratio changes between the protruding sections and the separation regions on the discrete type magnetic recording medium 40 opposite to the head slider, the wind pressure received by the head slider changes, thereby changing the floating level of the magnetic head. Therefore, in order to stabilize the floating level of the magnetic head, the smaller the variance in the area ratio between the protruding sections and the separation regions on the discrete type magnetic recording medium 40, the more preferable.

In those cases where the difference between the area ratio b of the separation regions 44a within the data region 41 and the area ratio c of the separation regions 44d within the landing region B is within the above-mentioned range, since the variance in the area ratio between the protruding sections and the separation regions on the discrete type magnetic recording medium 40 becomes small, the floating properties of the magnetic head when the magnetic head moves from the landing region B to the magnetic recording region A can be even more stabilized, and the extent of oscillation of the magnetic head when the magnetic head enters the servo information region 42 from the data region 41 can also be reduced, thereby preventing the magnetic head to momentarily come into contact with the magnetic recording medium more effectively.

In addition, in each of the area ratio, i.e., the area ratio a of the separation regions 44b within the servo information region 42 ((area of separation regions 44b)/(area of servo information region 42)×100), the area ratio b of the separation regions 44a within the data region 41, and the area ratio c of the separation regions 44d within the landing region B, the difference between the maximum value and the minimum value is preferably 10% or less. In this case, since the variance in the area ratio between the protruding sections and the separation regions on the discrete type magnetic recording medium 40 becomes extremely small, stability of the floating properties of the magnetic head will become even more excellent.

In addition, it is preferable that the area ratio a of the separation regions 44b within the servo information region 42 and the area ratio b of the separation regions 44a within the data region 41 satisfy the formula (1) shown below, and at the same time, the area ratio a of the separation regions 44b within the servo information region 42 and the area ratio c of the separation regions 44d within the landing region B satisfy the formula (2) shown below.

b−(b/10)≦a≦b+(b/10) (1)

c−(c/10)≦a≦c+(c/10) (2)

For example, when both the area ratio b of the separation regions 44a within the data region 41 and the area ratio c of the separation regions 44d within the landing region B are 15% (i.e., the area ratio of 85% for the protruding sections), it is preferable that the area ratio a of the separation regions 44b within the servo information region 42 be within a range from 13.5% to 16.5%. By making the area ratio a of the separation regions 44b within the servo information region 42 within the range so as to satisfy the above-mentioned formulae (1) and (2), in those cases where the magnetic head moves from the landing region B to the magnetic recording region A, moves from the servo information region 42 to the data region 41 or moves to the opposite directions, it is possible to effectively prevent the magnetic head to come into contact with the discrete type magnetic recording medium 40 without destabilizing the floating properties of the magnetic head.

In addition, it is preferable that all the area ratios ((area of separation regions)/(area of each region)×100) of the separation regions within each of the regions, i.e., the data region 41, the servo information region 42 and the landing region B, be within a range from 10% to 50%. By making all the area ratios of the separation regions within the above-mentioned respective regions within a range from 10% to 50%, it becomes possible to make the magnetic head float even more stably, and at the same time, it becomes possible to achieve even more excellent electromagnetic conversion characteristics.

When the area ratios of the separation regions within the above-mentioned respective regions are less than 10%, although the floating properties of the magnetic head become stable, separation between the tracks in the data region 41 may not be satisfactory. In addition, when the area ratios of the separation regions within the above-mentioned respective regions exceed 50%, the floating properties of the magnetic head may become unstable due to the air vortex generated by the recessed separating regions.

Furthermore, by making all the area ratios ((area of separation regions)/(area of each region)×100) of the separation regions within each of the regions, i.e., the data region 41, the servo information region 42 and the landing region B, to be within a range from 10% to 50%, and also by making the area ratio a of the separation regions 44b within the servo information region 42 to be within a range so as to satisfy the above formulae (1) and (2), the magnetic head can be floated more stably above the surface of the discrete type magnetic recording medium 40, and more excellent electromagnetic conversion characteristics can be achieved.

Here, the relationship between the discrete type magnetic recording medium 40 shown in FIG. 1 and the magnetic head moving while floating above the surface of the discrete type magnetic recording medium 40 will be described.

A magnetic head 26 shown in FIG. 3 is provided on a head slider 24 provided on the top end side of a suspension arm 21 of a head gimbal assembly. The magnetic head 26 is arranged in a trading side, which is opposite to a reading side where the slope of the head slider 24 is formed, at a part close to the discrete type magnetic recording medium 40. As shown in FIG. 3, the magnetic head 26 moves while floating above the surface of the discrete type magnetic recording medium 40.

The size of the head slider 24 to which the magnetic head 26 is attached is set to about 0.5 to 2 mm square. As shown in FIG. 3, since the head slider 24 travels above the surface of the discrete type magnetic recording medium 40 in an inclined posture, it does not necessarily be affected throughout the entire opposing surface thereof by the unevenness of the surface of the discrete type magnetic recording medium 40. According to the study by the present inventors, it has become apparent that in the normal head sliders, an opposing surface area of about 500 μm square is affected by the unevenness of the surface of the magnetic recording medium. In addition, each of the uneven patterns 47, the data patterns 45 and the servo patterns 46 is formed with a pitch of a few tens of nanometers to a few hundreds of nanometers. Accordingly, a pattern formed on the surface of the discrete type magnetic recording medium 40 is sufficiently small with respect to a region of about 500 μm square which is the opposing surface area of the head slider 24, and the area ratios (ratio of dents and projections) of the separation regions constituting these patterns are averaged due to the size of the head slider 24.

Therefore, the expression “the area ratios of the separation regions within the above-mentioned respective regions” substantially refers to “the area ratios of the separation regions of the discrete type magnetic recording medium 40 within the surface area opposing the head slider 24”.

In addition, in the discrete type magnetic recording medium 40 of the present embodiment, as the substrate 1, any substrate can be used as long as it is a disc-shaped substrate, such as Al alloy substrates made of, for example, an Al—Mg alloy or the like, which are composed mainly of aluminum, or substrates made of ordinary soda glass, aluminosilicate-based glass, crystallized glass, silicon, titanium, ceramics, and various resins. Among these, it is preferable to use an Al alloy substrate, a substrate made of glass such as crystallized glass, or a silicon substrate. In addition, the average surface roughness (Ra) of these substrates is not more than 1 nm, preferably not more than 0.5 nm and more preferably not more than 0.1 nm.

Further, the magnetic layer 2 is preferably formed from an alloy containing Co as the major component thereof.

For example, as a magnetic layer for an in-plane magnetic recording medium, a laminated structure composed of a nonmagnetic CrMo underlayer and a ferromagnetic CoCrPtTa magnetic layer can be used.

In addition, as a magnetic layer for a perpendicular magnetic recording medium, for example a laminate or the like which is composed of a backing layer made of a soft magnetic material, an orientation control film and a magnetic film can be used.

Examples of the backing layer include those constituted of a FeCo alloy (such as FeCoB, FeCoSiB, FeCoZr, FeCoZrB and FeCoZrBCu), a FeTa alloy (such as FeTaN and FeTaC), a Co alloy (such as CoTaZr, CoZrNB and CoB) or the like.

The backing layer preferably has a laminated structure, and can be made, for example, by providing an intermediate layer composed of any one of Ru, Re, and Cu between the soft magnetic films constituting the backing layer and making it into a predetermined thickness so that the soft magnetic films that are present above and below the layer are antiferromagnetically coupled.

In addition, examples of the orientation control film include those composed of Pt, Pd, NiCr, NiFeCr or the like.

Examples of the magnetic film include those constituted of a 60Co-15Cr-15Pt alloy or a 70Co-5Cr-15Pt-10SiO₂ alloy. In addition, as the magnetic film, it is preferable to use those made of a magnetic material having a granular structure. Here, a magnetic material having a granular structure refers to a magnetic material having a structure in which an oxide covers the circumference of a magnetic material particle. As an oxide included in the granular structure, apart from the above-mentioned SiO₂, a Ti oxide, a W oxide, a Cr oxide, a Co oxide, a Ta oxide, a Ru oxide or the like is used.

Since the magnetic crystal is separated by a non-magnetic phase in the magnetic material having a granular structure, magnetic interaction between the magnetic particles is weak, and also the magnetic crystal grains are fine, and thus the magnetic layer of extremely low noise can be formed. In addition, in those cases where a magnetic film made of a magnetic material having a granular structure is non-magnetized by using oxygen or ozone, an oxide present in the grain boundary can be selectively etched by employing a reactive ion etching apparatus using fluorine-based gas, an oxidation reaction between the metal, such as Co in the magnetic film, and oxygen and ozone can be promoted, the magnetic properties of the magnetic film can be changed more efficiently, and a reactivity during the formation of the magnetic properties-impaired region 48 formed by non-magnetizing the magnetic film can be enhanced.

In addition, the magnetic layer 2 may be formed into a double layer structure constituted of a magnetic layer having a granular structure and a magnetic layer formed thereon, which has a non-granular structure.

The thickness of the magnetic layer 2 is set to be equal to or more than 3 nm and equal to or less than 20 nm, and preferably equal to or more than 5 nm and equal to or less than 15 nm. The magnetic layer 2 may be formed so that a sufficient input and output performance of the head can be achieved in accordance with the type and lamination structure of the magnetic alloy to be used. In addition, the thickness of the magnetic layer 2 needs to be equal to or more than a certain thickness in order to obtain predetermined output greater than certain output at the time of reproduction. On the other hand, since various parameters representing the recording and reproducing characteristics are usually impaired as the level of output increases, it is necessary to set the above thickness to the optimum thickness.

### <Manufacturing Method of Discrete Type Magnetic Recording Medium>

Next, as a method for manufacturing the magnetic recording medium according to the present invention, a method for manufacturing the discrete type magnetic recording medium of the present embodiment shown in FIGS. 1 to 3 will be described in detail as an example.

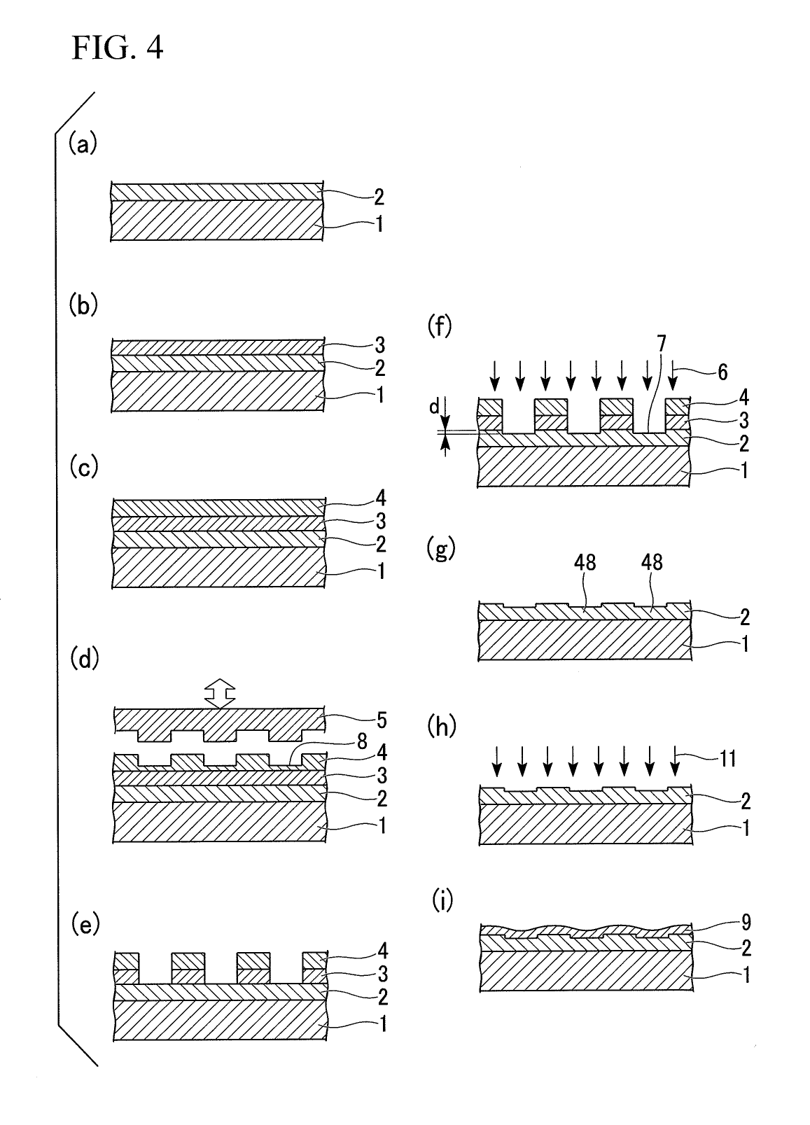

FIG. 4 is a schematic process drawing for explaining a method for manufacturing the discrete type magnetic recording medium of the present embodiment shown in FIGS. 1 to 3.

First, as shown in FIG. 4(a), the magnetic layer 2 is formed on top of the disc-shaped substrate 1 through a sputtering method or the like. Subsequently, as shown in FIG. 4(b), a carbon mask layer 3 is formed on top of the magnetic layer 2.

Although the carbon mask layer 3 can be formed either by a sputtering method or a chemical vapor deposition (CVD) method, the use of the CVD method enables the formation of a carbon film with higher denseness.

Since it is easy to subject the carbon mask layer 3 to a dry etching process (i.e., a reactive ion etching process or a reactive ion milling process) using oxygen gas, the amount of residue can be reduced and the level of contamination on the surface of the magnetic layer 2 can be reduced in the step for removing a resist layer to be described later by providing the carbon mask layer 3 on top of the magnetic layer 2.

The thickness of the carbon mask layer 3 is preferably within the range from 5 nm to 40 nm and more preferably within the range from 10 nm to 30 nm. If the thickness of the carbon mask layer 3 is less than 5 nm, the edge portion of the carbon mask layer 3 may be sagged, which may impair the formation characteristic of the respective patterns formed on top of the disc-shaped substrate 1 magnetic pattern. In addition, there is a possibility that when non-magnetizing a portion of the magnetic layer 2, oxygen or ozone passes through the carbon mask layer 3 and a resist layer formed on top of the carbon mask layer 3 and penetrates into the magnetic layer 2, thereby impairing the magnetic properties of the magnetic layer 2. On the other hand, if the thickness of the carbon mask layer 3 is thicker than 40 nm, a longer time for etching the carbon mask layer 3 will be required, and thus the productivity declines. In addition, if the thickness of the carbon mask layer 3 is thicker than 40 nm, the residues produced during etching of the carbon mask layer 3 are likely to remain on the surface of the magnetic layer 2.

Next, as shown in FIG. 4(c), a resist layer 4 is formed on top of the carbon mask layer 3, and as shown in FIG. 4(d), negative patterns for each of the patterns formed on top of the disc-shaped substrate 1 are formed on the resist layer 4. The negative patterns formed herein are those in which concave portions corresponding to the recessed separating regions that constitute each of the patterns are formed on the resist layer 4.

In terms of the method for forming a negative pattern on the resist layer 4, a normal photolithography technique can be employed. However, as shown in FIG. 4(d), it is preferable to use a method in which the shape of the respective patterns is transferred using a stamp 5 on the resist layer 4 from the viewpoint of working efficiency.

In addition, in the present manufacturing step, the thickness of a resist layer 8 remaining in the concave portion of the resist layer 4 following the formation of a negative pattern using the stamp 5 is preferably within a range from 0 to 20 nm. By making the thickness of the resist layer 8 remained in the concave portion of the resist layer 4 within this range, in the step for etching the carbon mask layer 3 and the magnetic layer 2, sagging in the edge portion of the carbon mask layer 3 can be avoided, the shielding properties of the carbon mask layer 3 with respect to the milling ions can be improved, and the properties for forming the respective patterns by the carbon mask layer 3 can also be improved.

Next, as shown in FIG. 4(e), the resist layer 8 remained after formation of the negative pattern and portions of the carbon mask layer 3 that correspond to the recessed separating regions constituting each of the patterns are removed. As a result, a mask layer constituted of the carbon mask layer 3 and the resist layer 4 is formed in a region to become a protruding section on top of the magnetic layer 2.

The resist layer 8 remained after formation of the negative pattern using the stamp 5 can be removed by a dry etching process such as a reactive ion etching process and an ion milling process. In addition, portions of the carbon mask layer 3 that correspond to the recessed separating regions constituting each of the patterns can be removed by a dry etching process such as a reactive ion etching process and an ion milling process.

Note that in the present embodiment, it is preferable to subject the resist layer 4 to the radiation exposure during the step of transferring a pattern to the resist layer 4 using the stamp 5 by employing a material curable by the radiation exposure for the resist layer 4, or after the pattern transferring step.

By using such a manufacturing method, it is possible to transfer the shape of the stamp 5 to the resist layer 4 with high precision. In addition, in the step for etching the carbon mask layer 3, sagging in the edge portion of the carbon mask layer 3 can be avoided, the shielding properties of the carbon mask layer 3 with respect to the milling ions can be improved, and the properties for forming the respective patterns by the carbon mask layer 3 can also be improved.

It should be noted that the term “radiation” used in the present invention is a concept that includes a wide range of electromagnetic waves, such as heat ray, visible light, ultraviolet ray, X-ray and gamma ray. In addition, radiation-curable materials refer to, for example, a thermosetting resin when the radiation is heat ray and an ultraviolet curing resin when the radiation is ultraviolet ray.

In the present manufacturing step, in the step of transferring a pattern onto the resist layer 4 using the stamp 5, the stamp 5 is pressed against the resist layer 4 in a state in which the fluidity of the resist layer 4 is high, and while the stamp 5 is being pressed, the resist layer 4 is cured by irradiating radiation thereto. The stamp 5 is then removed from the resist layer 4, and as a result, the shape of the stamp 5 can be transferred to the resist layer 4 with high precision.

In terms of the method for irradiating the resist layer 4 with radiation while the stamp 5 is being pressed against the resist layer 4, a method in which the resist layer 4 is irradiated from the opposite side of the stamp 5, i.e., a side of the substrate 1, a method in which the resist layer 4 is irradiated from the side of the stamp 5 by selecting a radiation-transmissive material as the material for the stamp 5, a method in which the resist layer 4 is irradiated from a side surface of the stamp 5, and a method in which the resist layer 4 is irradiated by heat conduction from the stamp material or the substrate 1 using highly conductive radiation with respect to a solid material, such as heat ray, can be employed. In such a case, it is particularly preferable to use an ultraviolet curable resin such as a novolak-based resin, an acrylic ester or an alicyclic epoxy as the resist material, and to use glass or resin having high transmittance with respect to the ultraviolet rays as the stamp material.

In addition, in the present manufacturing step, as a resist material, it is particularly preferable to use a SiO₂-based resist material. The SiO₂-based resist material is highly resistant to a dry etching process using oxygen gas. Accordingly, when forming a negative pattern on the carbon mask layer 3 using an ion milling process, the blurring of images can be reduced. In other words, the carbon mask layer 3 can be readily processed by a dry etching process using oxygen gas, whereas the SiO₂-based resist material is highly resistant to a dry etching process using oxygen gas. As a result, it becomes possible to process the carbon mask layer 3 into a shape standing upright by a dry etching process, which can provide a sharp configuration for the respective patterns.

Next, as shown in FIG. 4(f), the surface layer portion of the magnetic layer 2 in a region which is exposed due to the removal of the carbon mask layer 3 and which is to become a recessed separating region constituting the respective patterns is removed to a depth within a range from 0.1 nm to 15 nm by, for example, ion milling 6.

In some cases, the surface layer portion of the magnetic layer 2 exposed as a result of the removal of the carbon mask layer 3 may be deteriorated under the influence of the carbon mask layer 3 laminated on top of the magnetic layer 2 thereon or the influence of the atmosphere. When the magnetic layer 2 deteriorates, the non-magnetizing reaction of the magnetic layer 2 may not work effectively at times.

The surface layer portion of the magnetic layer 2 exposed as a result of the removal of the carbon mask layer 3 can be removed, for example, by a dry etching process such as an ion milling process following the removal of the carbon mask layer 3 by a dry etching process such as a reactive ion etching process. By adopting such a method, the edge portion of the magnetic layer 2 remained after the removal of the surface layer portion can be formed perpendicularly. This is because since the carbon mask layer 3 formed on top of the magnetic layer 2 has a shape standing upright, the magnetic layer 2 formed therebelow also will have a similar configuration. By adopting such a step, the magnetic layer 2 with excellent fringe properties can be formed.

Note that in the present manufacturing step, it is preferable to perform the reactive ion etching of the carbon mask layer 3 using oxygen gas, and it is also preferable to perform the ion milling of the magnetic layer 2 using inert gas, such as argon and nitrogen. That is, it is preferable to change the dry etching process for the carbon mask layer 3 and the dry etching process for the magnetic layer 2 with an optimal process, respectively.

In addition, it is also preferable to expose the surface of a region of the magnetic layer 2, which is exposed due to the removal of the carbon mask layer 3 and which is to be non-magnetized, to fluorine-based gas prior to the non-magnetization of the magnetic layer 2. By conducting such a treatment, the reactivity of the surface of the magnetic layer 2 to be non-magnetized can be enhanced, and the non-magnetizing reaction can be performed more efficiently.

Next, the magnetic properties of a region 7 of the magnetic layer 2 in which the surface layer portion is removed is modifyed and non-magnetized, thereby forming the magnetic properties-impaired region 48. The non-magnetization (modifying) of the magnetic layer 2 can be carried out by, for example, a method exposing to oxygen or ozone, a method irradiating laser, or the like. In the present manufacturing step, it is preferable to expose the region 7 from which the surface layer portion is removed to fluorine-based gas prior to the non-magnetization of the magnetic layer 2.

Following the non-magnetization of the magnetic layer 2, as shown in FIG. 4G, the resist 4 provided on top of the magnetic layer 2 and the carbon mask layer 3 are removed, thereby removing the mask layer. It is preferable to remove the resist layer 4 and the carbon mask layer 3 using a technique such as a dry etching process, a reactive ion etching process and an ion milling process.

After removing the mask layer, as shown in FIG. 4(h), it is preferable to irradiate the magnetic layer 2 with an inert gas 11 such as Ar so as to remove the surface layer portion of the magnetic layer 2 by etching within a range from 1 to 2 nm. As a result, by conducting a non-magnetization treatment on the magnetic layer 2, even when the surface of the magnetic layer 2 is roughened, the roughened surface of the magnetic layer 2 can be removed.

Subsequently, as shown in FIG. 4(i), it is preferable to form a protective film layer 9 on top of the magnetic layer 2. Normally, the protective film layer 9 is formed by a sputtering method or a CVD method.

For the protective film layer 9, a carbonaceous layer composed of carbon (C), hydrogenated carbon (HxC), carbon nitride (CN), amorphous carbon, silicon carbide (SiC) or the like, or other materials that are usually employed as a protective film material, such as SiO₂, Zr₂O₃ and TiN can be used. Further, the protective film layer 9 may be constituted of two or more layers.

The thickness of the protective film layer 9 is preferably 10 nm or less. If the film thickness of the protective film layer 9 exceeds 10 nm, the distance between the magnetic head 26 and the magnetic layer 2 becomes large, which may make it impossible to obtain sufficient input and output signal strength.

Moreover, it is preferable to form a lubricating layer (not shown) on top of the protective film layer 9. Examples of the lubricant used for the lubricating layer include a fluorine-based lubricant, a hydrocarbon-based lubricant and a mixture thereof, and the lubricating layer is usually formed with a thickness of 1 to 4 nm.

In this manner, the discrete type magnetic recording medium 40 shown in FIGS. 1 to 3 is manufactured.

Although the discrete type magnetic recording medium 40 of the present embodiment is provided with the respective patterns, i.e., the data patterns 45 configured from protruding sections and recessed separating regions, the servo patterns 46 and the uneven patterns 47, on one surface of the substrate 1, since the uneven patterns 47 having the same shape as that of the data patterns 45 are provided all over the landing region B, the floating properties of the magnetic head 26 in the data region 41 and in the landing region B can be approximated, and thereby approximating the floating properties of the magnetic head 26 above most part of the region within the surface of the discrete type magnetic recording medium 40. As a result, in those cases where the magnetic head 26 moves from the landing region B to the magnetic recording region A, the extent of oscillation of the magnetic head 26 occurring in the boundary portion between the data region 41 and the servo information region 42 is alleviated. Accordingly, the discrete type magnetic recording medium 40 of the present embodiment exhibits excellent stability for the floating properties of the magnetic head 26 and is capable of preventing the magnetic head 26 from coming into contact with the discrete type magnetic recording medium 40.

Moreover, in the discrete type magnetic recording medium 40 of the present embodiment since the data patterns 45 and the uneven patterns 47 are configured into a regular uneven shape, stability for the floating properties of the magnetic head 26 will be highly excellent.

Further, the discrete type magnetic recording medium 40 of the present embodiment includes the data region 41 in which the data patterns 45 configured from protruding sections 43a constituted of the magnetic layer 2 and recessed separating regions 44a formed in the periphery of the protruding sections 43a are provided, and the servo information region 42 in which the servo patterns 46 configured from the protruding section and the separation region and having a different shape from that of the data patterns 45 when seen in plan view are provided, in the magnetic recording region A, it is possible to separate between the protruding sections constituted of the magnetic layer 2 by recessed separating regions and to magnetically isolate the protruding sections in a reliable manner.

Furthermore, since the discrete type magnetic recording medium 40 of the present embodiment is provided with the respective patterns, i.e., the data patterns 45, the servo patterns 46, and the uneven patterns 47 which are configured from the protruding sections and separation regions on one surface of the substrate 1, there is no need to carry out a step for filling in and smoothing the concave portions with a nonmagnetic material, and thus the magnetic recording medium 40 can be easily manufactured at a high production efficiency, as compared to the case where the step for filling in and smoothing the concave portions with a nonmagnetic material is carried out.

In addition, since the method for producing the discrete type magnetic recording medium 40 of the present embodiment is a method including a step for forming the magnetic layer 2 on top of the substrate 1; a step for forming a mask layer constituted of the carbon mask layer 3 and the resist layer 4 in regions on the magnetic layer 2 which are to become the protruding sections; a step for removing the surface layer portions of the magnetic layer 2 which are to become the separation regions; a step for non-magnetizing the region 7 of the magnetic layer 2 in which the surface layer portion has been removed; and a step for removing the mask layer, and the non-magnetization of the magnetic layer 2 is conducted after the surface layer portion of the regions of the magnetic layer 2 which are to become the separation regions has been removed, the reactivity of the surface of the magnetic layer 2 to be non-magnetized can be enhanced, and the non-magnetizing reaction can be performed efficiently.

It should be noted that although a discrete type magnetic recording medium is described in detail in the aforementioned present embodiment as one example of the magnetic recording medium of the present invention, the magnetic recording medium of the present invention can be applied to both a discrete type magnetic recording medium and a bit pattern type magnetic recording medium.

Furthermore, the respective patterns constituted of the protruding sections and the separation regions in the present invention may be a so-called bit pattern system in which these portions or regions are arranged with a certain level of regularity for each one bit.

In addition, although a magnetic recording medium in which the magnetic recording region and the landing region are provided on one surface of the substrate has been described as an example in the aforementioned embodiment, the magnetic recording region and the landing region may be provided on both surfaces of the substrate.

Further, although the landing region is arranged along the outer edge portion of the annular magnetic recording region, the landing region may be arranged along the inner edge portion of the magnetic recording region.

### <Magnetic Recording and Reproducing Apparatus>

Next, a magnetic recording and reproducing apparatus of the present invention will be described using an example.

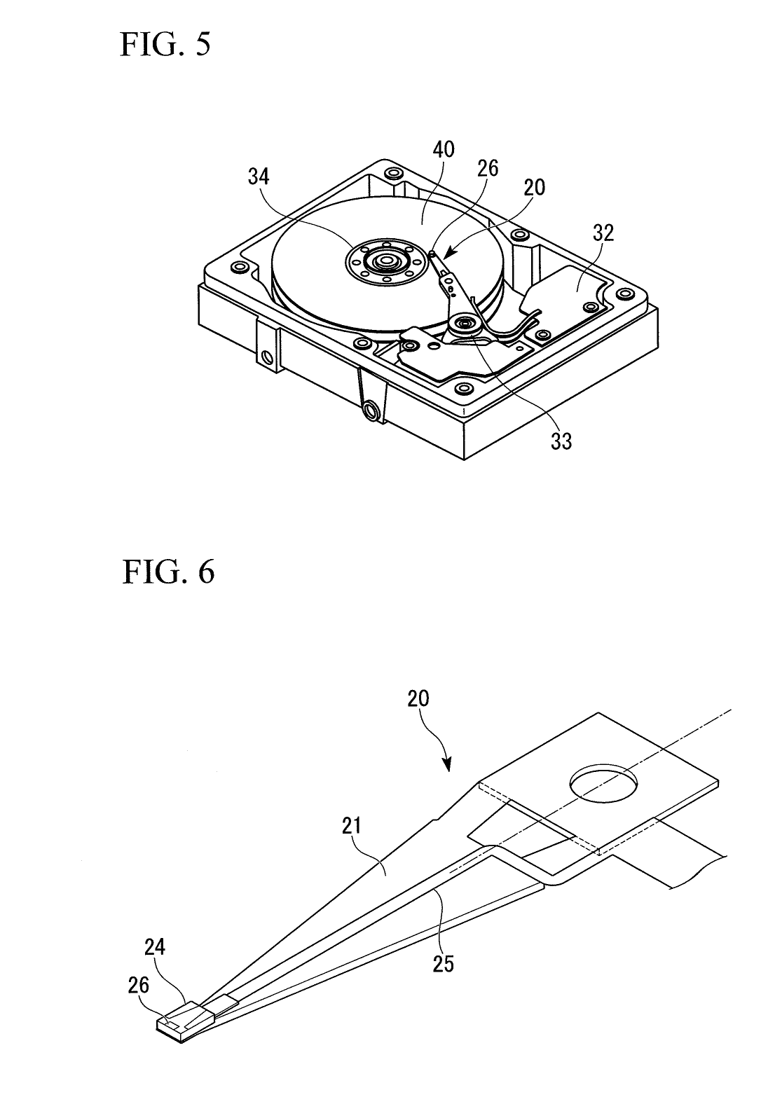

FIG. 5 is a schematic perspective view showing an example of a magnetic recording and reproducing apparatus of the present invention, and FIG. 6 is a schematic view showing a head gimbal assembly provided in the magnetic recording and reproducing apparatus shown in FIG. 5.

The magnetic recording and reproducing apparatus shown in FIG. 5 includes the discrete type magnetic recording medium 40 shown in FIG. 1, a medium drive section 34 which drives the magnetic recording medium 40 to the recording direction, the magnetic head 26 attached to a head gimbal assembly 20, a head drive section 33 which moves the magnetic head 26 relative to the discrete type magnetic recording medium 40, and a recording and reproducing signal system 32 (that is, a recording and reproducing signal processing device) for supplying input signals to the magnetic head 26 and for reproducing output signals from the magnetic head 26.

As shown in FIG. 6, the head gimbal assembly 20 includes a suspension arm 21 made of a thin metal plate, a head slider 24 provided on the top end side of a suspension arm 21, the magnetic head 26 provided on the head slider 24, and a controlling device (not shown) conductively connected by a signal line 25.

The magnetic head 26 is arranged in a trading side, which is opposite to a reading side where the slope of the head slider 24 is formed, at a part close to the discrete type magnetic recording medium 40.

The magnetic head 26 is constituted of a recording section and a reproducing section. For the magnetic head 26, it is possible to use a head suited for achieving high recording density which has not only a magnetoresistance (MR) element that uses a giant magnetoresistive effect but also a TMR element and the like that a uses tunnel-type magnetoresistive effect, as a reproducing element. Further, by using a TMR element, a higher recording density can be achieved.

Since the magnetic recording and reproducing apparatus shown in FIG. 5 includes the discrete type magnetic recording medium 40 shown in FIG. 1, the floating level of the magnetic head 26 can be reduced, and a high level of stability as well as high recording density can be achieved.

For example, if the magnetic head 26 is levitated so that the floating level thereof is within a height from 0.005 μm to 0.020 μm, which is lower than that in conventional cases, both the output and the device SNR are increased. As a result, a high-capacity and highly reliable magnetic recording and reproducing apparatus can be provided.

In addition, since the magnetic recording and reproducing apparatus shown in FIG. 5 includes the discrete type magnetic recording medium 40 in which a pattern configured from the protruding sections constituted of a magnetic layer and the recessed separating regions is provided, it is unlikely to be adversely affected by the adjacent tracks, and the apparatus can be operated, while making the head width for reproducing and the head width for recording substantially equal, without executing recording widely and executing reproduction more narrowly than during recording. Accordingly, in the magnetic recording and reproducing apparatus shown in FIG. 5, as compared to the cases where the head width for reproducing is made narrower than the head width for recording, a high reproducing output and a high signal to noise ratio (SNR) can be achieved.

Further, in the magnetic recording and reproducing apparatus shown in FIG. 5, by making the reproducing section of the magnetic head 26 constituted of a GMR head or a TMR head, sufficient signal strength can be obtained even under high recording density, and thus a magnetic recording and reproducing apparatus with high recording density can be provided.

In addition, in those cases where a signal processing circuit of a maximum likelihood decoding system is combined with the magnetic recording and reproducing apparatus shown in FIG. 5, the recording density can further be improved, and, for example, a sufficiently high SNR can be obtained even when the recording and reproducing are performed with a track density of not less than 100K tracks per inch, a linear recording density of 1000 KB per inch or a recording density of not less than 100 GB per 1 square inch.

### EXAMPLES

### Examples 1 to 11, Comparative Examples 1 to 9

First, a disc-shaped glass substrate for the hard disk (HD) was placed in a vacuum chamber, and the vacuum chamber was evacuated to a pressure of 1.0×10⁻⁵ Pa or less. Note that as the glass substrate, a substrate composed of crystallized glass containing Li₂Si₂O₅, Al₂O₃—K₂O, Al₂O₃—K₂O, MgO—P₂O₅ and Sb₂O₃—ZnO as the constituting components and having an outer diameter of 65 mm, an inner diameter of 20 mm and an average surface roughness (Ra) of 2 angstrom was used.

A magnetic layer, in which a backing layer constituted of a 60Fe30Co10B soft magnetic film, an intermediate layer constituted of Ru and a magnetic film having a granular structure and constituted of a 70Co-5Cr-15Pt-10SiO₂ alloy were laminated in this order, was formed on the glass substrate using a DC sputtering process. Subsequently, a thin film of a carbon mask layer was laminated on top of the magnetic layer using a P-CVD method.

The thickness of the backing layer was 60 nm, the thickness of the intermediate layer was 10 nm, the thickness of the magnetic film was 15 nm and the thickness of the carbon mask layer was 30 nm.

Then, a resist layer was formed by applying a SiO₂ resist onto this carbon mask layer by a spin coating method. The thickness of the resist layer was set to 100 nm.

Next, a glass stamp that corresponds to the respective pattern shapes of Examples 1 to 11 and Comparative Examples 1 to 9 was arranged on the resist layer, and the stamp was pressed against the resist layer at a pressure of 1 MPa (about 8.8 kgf/cm²). Thereafter, the stamp was removed from the resist layer and the pattern corresponding to each of the patterns of Examples 1 to 11 and Comparative Examples 1 to 9 was transferred to the resist layer, which was used as a negative pattern.

Here, as stamps for forming negative patterns, stamps having different shapes were used in Examples 1 to 11 and Comparative Examples 1 to 9, respectively.

Note that the thickness of the resist layer remained in the concave portion of the resist layer after formation of the negative pattern was 5 nm, and the thickness of the protruding section was 80 nm. In addition, the angle of the concave portion of the resist layer after formation of the negative pattern with respect to the substrate surface was about 90 degrees.

Next, the resist layer remaining in the concave portion was removed by a dry etching process. In terms of the conditions for dry etching, CF₄ was used at 0.5 Pa and 40 sccm with a plasma power of 200 W, a bias of 20 W and an etching time of 10 seconds.

Thereafter, portions of the carbon mask layer 3 exposed as a result of the removal of the resist layer which corresponded to the recessed separating regions constituting each of the patterns were removed by a reactive ion etching process. In terms of the conditions for reactive ion etching, the carbon mask layer was etched using O₂ gas of 40 sccm, a pressure of 0.3 Pa, a high-frequency plasma power of 300 W, a DC bias of 30 W and an etching time of 30 seconds.

Next, the surface layer portion of the magnetic layer in a region which was exposed due to the removal of the carbon mask layer and which was to become a recessed separating region constituting the respective patterns was removed by an ion milling process. In terms of the conditions for ion milling, N₂ gas of 10 sccm was used at a pressure of 0.1 Pa with an accelerating voltage of 300V and an etching time of 5 seconds. The depth of the concave portion of the magnetic layer formed herein was 1 nm.

Thereafter, a region of the magnetic layer in which the surface layer portion has been removed was exposed to ozone gas and non-magnetized. The magnetic layer was exposed to the ozone gas that flowed at 40 sccm in the chamber under the conditions of 1 Pa and 10 seconds with the substrate temperature of 150° C.

Following the non-magnetization of the magnetic layer, the resist layer provided on top of the magnetic layer and the carbon mask layer were removed by a dry etching process. Thereafter, in an ion milling apparatus, the surface of the magnetic layer was etched to a thickness range of about 1 to 2 nm using Ar gas of 10 sccm, 0.5 Pa and 5 seconds.

In this manner, on the glass substrates of Examples 1 to 11 and Comparative Examples 1 to 9, an annular magnetic recording region and a landing region arranged concentrically with respect to the substrate along the outer edge portion of the magnetic recording region and having a width of 1 mm were formed, and a data region and a band-like servo information region extending radially from the center while dividing the data region and having a width of 20 μm were formed in the magnetic recording region.

In addition, in the magnetic layer in the data region of Examples 1 to 11 and Comparative Examples 1 to 9, a data pattern configured from the protruding sections and the recessed separating regions formed in the periphery of the protruding sections was formed. The protruding sections and the separation regions that constitute the data pattern were extended in the circumferential direction of the substrate in a band-like manner at regular intervals, and the width of the protruding sections was 120 nm. In addition, the area ratio ((area of separation regions)/(area of data region)×100) of the separation regions within the data region was determined. Note that in Examples 1 to 11 and Comparative Examples 1 to 9, the area ratio of the separation regions within the data region was changed by changing the width of the separation regions. The results are shown in Table 1.

TABLE 1

| | Area ratio (%) | | | | Limit of |
|---|---|---|---|---|---|
| | Servo | | | | floating |
| | information | Data | Landing | | level |
| | region | region | region | Difference | (nm) |
| Ex. 1 | 50 | 60 | 50 | −10 | 6.5 |
| Ex. 2 | 50 | 55 | 50 | −5 | 5.5 |
| Ex. 3 | 50 | 50 | 50 | 0 | 4.6 |
| Ex. 4 | 50 | 45 | 50 | 5 | 5.7 |
| Ex. 5 | 50 | 40 | 50 | 10 | 6.6 |
| Ex. 6 | 30 | 40 | 30 | −10 | 5.7 |
| Ex. 7 | 30 | 30 | 30 | 0 | 4.2 |
| Ex. 8 | 30 | 20 | 30 | 10 | 5.9 |
| Ex. 9 | 10 | 17.5 | 10 | −7.5 | 5.8 |
| Ex. 10 | 10 | 10 | 10 | 0 | 4.3 |
| Ex. 11 | 10 | 5 | 10 | 5 | 5.2 |
| Comp. | 50 | 80 | None (smooth | −80 | 11.2 |
| Ex. 1 | | | surface) | | |
| Comp. | 50 | 70 | None (smooth | −70 | 9.5 |
| Ex. 2 | | | surface) | | |
| Comp. | 50 | 30 | None (smooth | −30 | 9.6 |
| Ex. 3 | | | surface) | | |
| Comp. | 50 | 20 | None (smooth | −20 | 10.1 |
| Ex. 4 | | | surface) | | |
| Comp. | 30 | 50 | None (smooth | −50 | 9.2 |
| Ex. 5 | | | surface) | | |
| Comp. | 30 | 20 | None (smooth | −20 | 9.7 |
| Ex. 6 | | | surface) | | |
| Comp. | 50 | 60 | None (smooth | −60 | 9.1 |
| Ex. 7 | | | surface) | | |
| Comp. | 50 | 55 | None (smooth | −55 | 8.6 |
| Ex. 8 | | | surface) | | |
| Comp. | 50 | 50 | None (smooth | −50 | 8.1 |
| Ex. 9 | | | surface) | | |

In addition, in the magnetic layer in the servo information region of Examples 1 to 11 and Comparative Examples 1 to 9, a servo pattern configured from the protruding sections and the recessed separating regions formed in the periphery of the protruding sections were formed. The protruding sections that constitute the servo pattern were arranged irregularly, and the width of the protruding sections was 120 nm. In addition, the area ratio ((area of separation regions)/(area of servo information region)×100) of the separation regions within the servo information region was determined. Note that the servo pattern has a different shape from that of the data pattern when seen in plan view, and in Examples 1 to 11 and Comparative Examples 1 to 9, the area ratio of the separation regions within the servo information region was changed by changing the plane shape of the servo pattern. The results are shown in Table 1.

In addition, among Examples 1 to 11 and Comparative Examples 1 to 9, only in Examples 1 to 11, an uneven pattern configured from the protruding sections and the recessed separating regions formed in the periphery of the protruding sections was formed in the magnetic layer in the landing region. The protruding sections and the separation regions that constitute the uneven pattern were extended in the circumferential direction of the substrate in a band-like manner at regular intervals, the width of the protruding sections was 120 nm, and the shape of the protruding sections of the uneven pattern was the same shape as that of the protruding sections of the data pattern. Note that in the magnetic layer in the landing region of Comparative Examples 1 to 9, no uneven pattern was formed, thereby making the landing region of Comparative Examples 1 to 9 as a smooth surface.

In addition, the area ratio ((area of separation regions)/(area of landing region)×100) of the separation regions within the landing region of Examples 1 to 11 and Comparative Examples 1 to 9 was determined. Note that in Examples 1 to 11 and Comparative Examples 1 to 9, the area ratio of the separation regions within the landing region was changed by changing the width of the separation regions. The results are shown in Table 1. It should be noted that when the landing region is a smooth surface, the area ratio of the landing region is 0.

Furthermore, the difference between the area ratio of the separation regions within the landing region and the area ratio of the separation regions within the data region (i.e., difference=(area ratio of landing region)−(area ratio of data region)) was determined. The results are shown in Table 1.

Subsequently, a protective film layer constituted of carbon and having a thickness of 5 nm was deposited by the CVD method on top of the magnetic layer where the respective patterns, i.e., the data pattern, the servo pattern and the uneven pattern had been provided. Thereafter, a fluorine-based lubricant was applied on top of the protective film layer to form a lubricating layer having a thickness of 2 nm, thereby obtaining the magnetic recording media of Examples 1 to 11 and Comparative Examples 1 to 9.

Then, the magnetic recording media of Examples 1 to 11 and Comparative Examples 1 to 9 were rotated at high speed, and the floating properties of the head slider having a width of 300 μm and a length of 500 μm were examined. Evaluation on the floating properties was carried out by measuring the limit of floating level at which the magnetic head comes into contact with the magnetic recording medium when the magnetic head moves from the withdrawn position to the magnetic recording region while passing through the landing region. The results of the measured limit of floating level are shown in Table 1.

As shown in Table 1, in Examples 1 to 11 in which an uneven pattern with the protruding sections having the same shape as that of the protruding sections in the data pattern was formed in the landing region, the limit of floating level became low, as compared to Comparative Examples 1 to 9 in which the landing region was made as a smooth surface.

In addition, as is apparent from the results shown in Table 1, in Examples 1 to 11, the limit of floating level was lower than in Comparative Example 9 in which the servo information region and the data region had the same area ratio. Accordingly, by forming, in the landing region, an uneven pattern with the protruding sections having the same shape as that of the protruding sections in the data pattern, the limit of floating level can be made low.

### INDUSTRIAL APPLICABILITY

According to the present invention, in the magnetic recording medium having a magnetic recording pattern with uneven shapes on the surface thereof, stability for the floating of the magnetic head can be secured. As a result, since it becomes possible to reduce the floating level of the magnetic head, a magnetic recording medium having excellent properties in terms of the high recording density can be manufactured.

### DESCRIPTION OF THE REFERENCE SYMBOLS

A: Magnetic recording region; B: Landing region; C: Setting position; d: Depth of the separation regions with respect to the protruding sections; L: Width of separation regions; W: Width of protruding sections; 1: Substrate; 2: Magnetic layer; 3: Carbon mask layer; 4: Resist layer; 5: Stamp; 9: Protective film layer; 20: Head gimbal assembly; 21: Suspension arm; 24: Head slider; 25: Signal line; 26: Magnetic head; 32: Recording and reproducing signal system; 33: Head drive section; 34: Medium drive section; 40: Discrete type magnetic recording medium; 41: Data region; 42: Servo information region; 43a, 43b, 43c, 43d: Protruding sections; 44a, 44b, 44d: Separation regions; 45: Data pattern; 46: Servo pattern; 47: Uneven pattern; 48: Magnetic properties-impaired region.

1. A magnetic recording medium comprising:
an annular magnetic recording region and
a landing region arranged along the edge portion of the magnetic recording region, on at least one surface of a disc-shaped substrate,
wherein the magnetic recording region comprises
a data region in which a data pattern configured from a protruding section constituted of a magnetic layer and a recessed separating region formed in the periphery of the protruding section is provided, and
a servo information region in which a servo pattern configured from the protruding section and the separation region and having a different shape from that of the data pattern when seen in plan view; and
the landing region comprises an uneven pattern having a protruding section with the same shape as that of the protruding section in the data pattern.

2. The magnetic recording medium according to claim 1,
wherein the landing region substantially does not have a protruding section with the same shape as that of the protruding section in the servo pattern.

3. The magnetic recording medium according to claim 1,
wherein a difference between the maximum value and the minimum value for an area ratio of the separation region within each of the data region, the servo information region and the landing region is 10% or less.

4. The magnetic recording medium according to claim 1,
wherein all area ratios of the separation region within each of the data region, the servo information region and the landing region are within a range from 10% to 50%.

5. The magnetic recording medium according to claim 1, wherein the protruding section in the data region is a track portion.

6. The magnetic recording medium according to claim 1,
wherein a depth of the separation region with respect to the protruding section is within a range from 0.1 nm to 15 nm.

7. The magnetic recording medium according to claim 1,
wherein the data pattern and the uneven pattern have a regular uneven shape configured from a protruding section and a separation region that are extended in the circumferential direction of the substrate in a band-like manner at regular intervals.

8. A magnetic recording and reproducing apparatus comprising:
the magnetic recording medium of claim 1;
a driving section for driving the magnetic recording medium in a recording direction;
a magnetic head constituted of a recording section and a reproducing section;
a device for moving the magnetic head relative to the magnetic recording medium; and
a recording/reproducing signal processing device for supplying input signals to the magnetic head and reproducing output signals from the magnetic head.

9. A method for manufacturing a magnetic recording medium which is a method for manufacturing the magnetic recording medium of claim 1, the method comprising, at least:
a step for forming a magnetic layer on top of the substrate;
a step for forming a mask layer in a region on the magnetic layer which is to become the protruding section;
a step for removing a surface layer portion of the magnetic layer in a region which is to become the separation region;
a step for modifying magnetic properties of the magnetic layer in a region where the surface layer portion has been removed; and
a step for removing the mask layer.
